(19) United States
(12) Patent Application Publication
(10) Pub. No.: US 2017/0040596 A1
(43) Pub. Date: Feb. 9, 2017

(54) METHODS FOR MAKING LITHIUM MANGANESE PHOSPHATE AND LITHIUM MANGANESE PHOSPHATE/CARBON COMPOSITE MATERIAL

(71) Applicants: JIANGSU HUADONG INSTITUTE OF LI-ION BATTERY CO., LTD., Suzhou (CN); TSINGHUA UNIVERSITY, Beijing (CN)

(72) Inventors: Li Wang, Beijing (CN); Xiang-Ming He, Beijing (CN); Shao-Jun Liu, Suzhou (CN); Jian-Li Zhang, Suzhou (CN); Jing Luo, Suzhou (CN); Yu-Ming Shang, Beijing (CN); Jian-Jun Li, Beijing (CN); Jian Gao, Beijing (CN); Yumei Ren, Suzhou (CN); Hong-Sheng Zhang, Suzhou (CN)

(73) Assignees: JIANGSU HUADONG INSTITUTE OF LI-ION BATTERY CO., LTD., Suzhou (CN); TSINGHUA UNIVERSITY, Beijing (CN)

(21) Appl. No.: 15/333,907

(22) Filed: Oct. 25, 2016

Related U.S. Application Data
(63) Continuation of application No. PCT/CN2015/077107, filed on Apr. 21, 2015.

(30) Foreign Application Priority Data
Apr. 29, 2014 (CN) 201410175848.8

(51) Int. Cl. H01M 4/1397; H01M 4/136; C01B 25/45; H01M 4/58; H01M 4/04; H01M 10/0525; H01M 4/62

(52) U.S. Cl. CPC H01M 4/1397; H01M 10/0525; H01M 4/136; H01M 4/625; H01M 4/5825; H01M 4/0471; C01B 25/45; C01P 2006/40

(57) ABSTRACT

A method for making lithium manganese phosphate is disclosed. A divalent manganese source, a lithium source and a phosphate source are mixed and dissolved in a solvothermal reaction medium to form a mixed solution. The solvothermal reaction medium includes an organic solvent and a solubilizing agent. The mixed solution is then solvothermal reacted. A method for making lithium manganese phosphate/carbon composite material is also disclosed.

### CROSS-REFERENCE TO RELATED APPLICATIONS

This application claims all benefits accruing under 35 U.S.C. §119 from China Patent Application No. 201410175848.8, filed on Apr. 29, 2014 in the China Intellectual Property Office, the content of which is hereby incorporated by reference. This application is a continuation under 35 U.S.C. §120 of international patent application PCT/CN2015/077107 filed Apr. 21, 2015.

### FIELD

The present disclosure relates to methods for making cathode materials of lithium ion batteries, and particularly to methods for making lithium manganese phosphate and lithium manganese phosphate/carbon composite material.

### BACKGROUND

Olivine structure lithium metal phosphates LiMPO₄ are cathode active materials in lithium ion batteries, with advantages including environmental friendliness, high voltage platform, stable cycling performance, and excellent safety. Lithium iron phosphate (LiFePO₄), as a lithium metal phosphate, has a theoretical capacity of 170 mAh/g and superior cycling capability and a voltage plateau of 3.4 V vs. Li⁺/Li. Lithium manganese phosphate (LiMnPO₄), as another lithium metal phosphate, has a voltage plateau of 4.1 V vs. Li⁺/Li, and has better energy density compared with LiFePO₄. However, LiMnPO₄ has a relatively low electronic conductivity which is a restriction of its application.

### BRIEF DESCRIPTION OF THE DRAWINGS

Implementations are described by way of example only with reference to the attached figures.

FIG. 1 is a flow chart of an embodiment of a method for making lithium manganese phosphate.

FIG. 2 is a flow chart of an embodiment of a method for making lithium manganese phosphate/carbon composite material.

FIG. 3 shows an X-ray diffraction (XRD) pattern of one embodiment of lithium manganese phosphate formed in Example 1.

FIG. 4 is a graph showing discharge voltage curves of lithium ion batteries having lithium manganese phosphate/carbon composites formed in Examples 1 to 5 and Comparative Examples 1 to 2.

FIG. 5 is graph showing cycling performance of lithium manganese phosphate/carbon composite formed in Example 2 at 1 C current rate.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

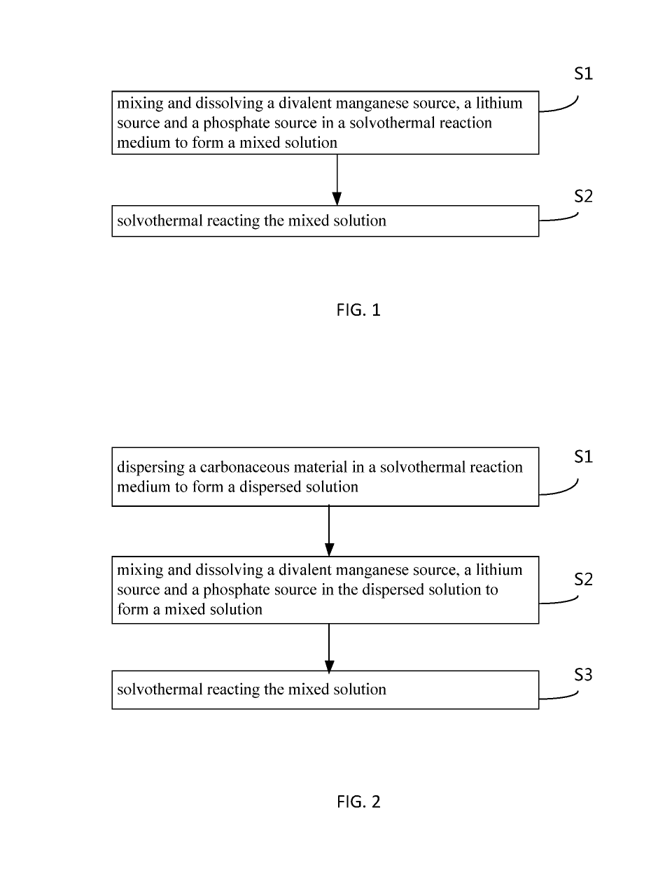

Referring to FIG. 1, one embodiment of a method for making lithium manganese phosphate comprises steps of:

S1, mixing and dissolving a divalent manganese (Mn²⁺) source, a lithium (Li⁺) source, and a phosphate (PO₄³⁺) source in a solvothermal reaction medium to form a mixed solution, the solvothermal reaction medium comprising an organic solvent and a solubilizing agent; and

S2, solvothermal reacting the mixed solution to obtain the lithium manganese phosphate.

The divalent manganese source can be selected from at least one of manganese chloride, manganese nitrate, manganese sulfate, manganese acetate, and combinations thereof.

The lithium source can be selected from at least one of lithium hydroxide, lithium acetate, lithium carbonate, lithium oxalate, and combinations thereof.

The phosphate source can be selected from at least one of phosphoric acid (H₃PO₄), lithium dihydrogen phosphate (LiH₂PO₄), ammonium phosphate ((NH₄)₃PO₄), diammonium hydrogen phosphate ((NH₄)₂HPO₄), ammonium dihydrogen phosphate (NH₄H₂PO₄), and combinations thereof.

Step S1 can further comprise dissolving a metal doping source with the divalent manganese source, the lithium source, and the phosphate source in the solvothermal reaction medium to form the mixed solution comprising the metal dopant source, the divalent manganese source, the lithium source, and the phosphate source mixed with each other. The doping element in the metal doping source can be selected from at least one of alkaline-earth metal elements, Group-13 elements, Group-14 elements, transition metal elements, and rare-earth elements. In some embodiments, the doping element can be at least one of Fe, Mg, Ni, Co, Zn, Cu, V, Al, and Mo. When the doping element is Fe, the product formed in step S2 is a metal-doped lithium manganese phosphate having a chemical formula of LiMn₍₁₋ₓ₎FeₓPO₄, where 0<x<1.

The divalent manganese source, the metal doping source, the lithium source, and the phosphate source are all soluble in the organic solvent. That is, Mn²⁺, Li⁺, PO₄³⁺ and doping metal ions (M²⁺) are capable of being formed in the organic solvent.

The amount of the divalent manganese source, the metal doping source, the lithium source, and the phosphate source added in the organic solvent can be calculated according to the chemical formula LiMn₍₁₋ₓ₎MₓPO_{4,} where 0≦x<1. That is, a theoretical molar ratio among Li, M, Mn, and P is Li:(M+Mn):P=1:1:1. However, the lithium and phosphorus elements can be greater. The divalent manganese source, the metal doping source, the lithium source, and the phosphate source can be mixed in a molar ratio of Li:(M+Mn):P=(2.5 to 3.5):1:(0.5 to 1.5).

The organic solvent is capable of dissolving the divalent manganese source, the metal doping source, the lithium source, and the phosphate source. The organic solvent can be diols and/or polyols, such as at least one of ethylene glycol, glycerol, diethylene glycol, triethylene glycol, tetraethylene glycol, butanetriol, n-butanol, and isobutanol. The material of the organic solvent can be selected according to the material of the divalent manganese source, the metal doping source, the lithium source, and the phosphate source. Because none of the divalent manganese source, the metal doping source, the lithium source, and the phosphate source has a high solubility in the organic solvent, the solubilizing agent is added to increase the solubility of at least one of the divalent manganese source, the metal doping source, the lithium source, and the phosphate source in the organic solvent. The solubilizing agent can be selected from at least one of alkyl phenol polyoxyethylene ether (APEO), fatty alcohol ethoxylate (AE), polyethylene glycol (PEG) and polyolester. The solubilizing agent in the organic solvent does not exist in an ionic state, has a high stability, and is not affected by the presence of strong electrolytes, acids, or alkalis. Even a small amount of the solubilizing agent can increase the solubility. In one embodiment, a volume ratio of the organic solvent and the solubilizing agent can be in a range from about 9:1 to about 3:2. For manganese, as long as water is present in the solvent, there is a problem of oxidation of Mn²⁺. A small amount of Mn³⁺ can greatly reduce the charge and discharge capacity of LiMnPO₄. In addition, water has a great influence on the morphology and electrochemical performance of the product. The solvothermal reaction medium can be water-free. The divalent manganese source, the metal doping source, the lithium source, and the phosphate source may comprise crystal water. In particular, a mass percentage of water in the mixed solution can be smaller than 1%.

In one embodiment, step S1 can further comprise:

S11, respectively providing the divalent manganese source solution, the lithium source solution, and the phosphate source solution;

S12, adding the phosphate source solution portion by portion to the divalent manganese source solution to form a first liquid solution; and

S13, adding the first liquid solution portion by portion to the lithium source solution to form the mixed solution.

In step S11, the divalent manganese source solution, the lithium source solution, and the phosphate source solution are all in liquid form. The divalent manganese source solution comprises Mn²⁺, the lithium source solution comprises Li⁺, and the phosphate source solution comprises PO₄³⁺. Each of the divalent manganese source solution, the lithium source solution, and the phosphate source solution comprises an organic solvent. At least one of the divalent manganese source solution, the lithium source solution, and the phosphate source solution comprises the solubilizing agent. In one embodiment, the divalent manganese source solution comprises the solubilizing agent.

In step S12, the phosphate source solution reacts with the divalent manganese source solution to form a manganese (II) phosphate in an ionic state in the first liquid solution. That is, there is no solid deposition in the first liquid solution, and the first liquid solution is a clear liquid. The portion by portion can be drop by drop. During step S12, the first liquid solution can be stirred to uniformly mix the phosphate source solution with the divalent manganese source solution and to promote the reaction. A stirring time can be about 0.5 hours to about 24 hours. A molar ratio of the phosphate source to the divalent manganese source can be 0.5:1 to 1.5:1.

In step S13, the first liquid solution reacts with the lithium source solution to form an insoluble intermediate product, which is a solid deposition in the mixed solution. The portion by portion can be drop by drop. During step S13, the mixed solution can be stirred to uniformly mix the first liquid solution with the lithium source solution and to promote the reaction. A stirring time can be about 0.5 hours to about 24 hours. A molar ratio of the lithium source to the divalent manganese source can be 2.5:1 to 3.5:1.

In step S2, the solvothermal reacting can be carried out in a solvothermal reactor at a temperature of about 120° C. to about 240° C. The solvothermal reactor can be an autoclave. In the solvothermal reacting, the pressure inside the reactor is increased by applying an additional pressure to the inside of the reactor or vaporizing the solvent in the reactor to form a self-generating pressure, so that the reactants inside the reactor are subjected to a high temperature and a high pressure. The internal pressure of the reactor can be about 0.2 MPa to about 30 MPa, and the solvothermal reacting time is about 2 hours to about 24 hours. The reaction product is LiMn₍₁₋ₓ₎MₓPO₄ having a particle size of about 100 nm to about 300 nm. After step S2, the reactor can be naturally cooled to room temperature. The reaction product can be taken out from the reactor, washed and dried. More specifically, the reaction product can be washed with deionized water, filtered or centrifuged, and dried in oven.

After step S2, the method can further comprises a step S3 of heating the lithium manganese phosphate in a protective gas at about 200° C. to about 800° C. Before the heating, the lithium manganese phosphate can be mixed with a carbon source to form a mixture. The mixture can be heated in a protective atmosphere at about 200° C. to about 800° C. for about 2 hours to about 20 hours, and naturally cooled to room temperature, thereby obtaining an olivine type lithium manganese phosphate/carbon composite material. The carbon source can be at least one of glucose, sucrose, fructose, lactose, starch, carbon black (e.g., Super P), polyvinyl chloride (PVC), polyvinyl alcohol (PVA), polyvinyl butyral (PVB), polyacrylonitrile (PAN), and phenolic resin. The protective atmosphere can be at least one of argon gas, nitrogen gas, hydrogen-nitrogen mixed gas and hydrogen-argon mixed gas.

Referring to FIG. 2, one embodiment of a method for making lithium manganese phosphate/carbon composite material comprises steps of:

A1, dispersing carbonaceous material in a solvothermal reaction medium to form a dispersed solution, the solvothermal reaction medium comprising an organic solvent and a solubilizing agent, and the carbonaceous material is at least one of graphene, carbon nanotubes, carbon nanofibers, and carbon nanoballs.

A2, mixing and dissolving a divalent manganese (Mn²⁺) source, a lithium (Li⁺) source, and a phosphate (PO₄³⁺) source in the dispersed solution to form a mixed solution; and

A3, solvothermal reacting the mixed solution to obtain the lithium manganese phosphate/carbon composite material.

The steps A2 and A3 are substantially the same as steps S1 and S2, except that the dispersed solution comprises the carbonaceous material dispersed therein.

In step A1, the carbonaceous material can comprise graphene oxide, which can be prepared by a conventional method such as Brodie method, Hummers method or Staudenmaier method. In one embodiment, the graphene oxide can be prepared by a method comprising steps of:

mixing graphite, concentrated sulfuric acid, and sodium nitrate to form a mixture;

adding potassium permanganate while stirring the mixture at a temperature in a range from about 0° C. to about 4° C., and maintaining the temperature of the mixture below 20° C.;

stirring the mixture at a temperature of about 35° C.;

adding water to the mixture under stirring and achieving a temperature of about 98° C. to about 100° C. of the mixture;

adding an aqueous solution of hydrogen peroxide to the mixture; and

filtering a solid phase out from the mixture to obtain the graphene oxide.

Alternatively, an oxidized graphite can be prepared previously, and the oxidized graphite can be formed into oxidized graphene under ultrasonic vibration in a solvent such as water.

In one embodiment, the oxidized graphene dispersed in the solvothermal reaction medium is a graphene oxide solution obtained directly from the Hummers method. The graphene oxide solution is added to the solvothermal reaction medium, centrifugally separated and ultrasonically dispersed to obtain the dispersed solution. Specifically, when the graphene oxide solution contains water, the solids are retained after centrifugation, and the supernatant water is removed. The solvothermal reaction medium is then added to the solids and centrifuged again. The centrifugation and the addition of the solvothermal reaction medium are repeated at least several times to remove the water while dispersing the graphene oxide in the solvothermal reaction medium.

In one embodiment, the step A2 further comprises steps of:

A21, respectively providing the lithium source solution and the phosphate source solution, and forming the divalent manganese source solution by dissolving the divalent manganese source in the dispersed solution;

A22, adding the phosphate source solution portion by portion to the divalent manganese source solution to form a second liquid solution; and

A23, adding the second liquid solution portion by portion to the lithium source solution to form the mixed solution.

Steps A21 to A23 can be substantially the same as steps S11 to S13, except that the divalent manganese source solution comprises the carbonaceous material dispersed therein.

The method can further comprise a step A4 of heating the lithium manganese phosphate/carbon composite material in a protective gas at about 200° C. to about 800° C. Before heating, the lithium manganese phosphate/carbon composite material can be mixed with a carbon source to form a mixture. The mixture can be heated in a protective atmosphere at about 200° C. to about 800° C. for about 2 hours to about 20 hours, and naturally cooled to room temperature, thereby obtaining an olivine type lithium manganese phosphate/carbon composite material.

In the lithium manganese phosphate/carbon composite material, the lithium manganese phosphate nano particles are uniformly dispersed in micropores formed from the interwoven of the carbon materials. The particle size of the lithium manganese phosphate nano particles can be in a range from about 100 nm to about 300 nm. The carbon materials have good electrical conductivity, excellent mechanical property, a high specific surface area, and a network structure suitable for an ion transportation of electrolyte. The lithium manganese phosphate can be used as a cathode active material of lithium ion battery with good electrochemical performance.

The methods in the present disclosure adopt solvothermal synthesis, and can produce manganese phosphate lithium crystal which has few defects, good orientation, and perfect crystalline form at a relatively low temperature. The lithium manganese phosphate and the lithium manganese phosphate/carbon composite material are nanosized materials, which have a particle size of about 100 nm to about 300 nm, a large specific surface area, and a small Li⁺ intercalation/deintercalation depth. Accordingly, the electrodes using the lithium manganese phosphate and the lithium manganese phosphate/carbon composite material can be charged and discharged at a relatively large current rate, and have good reversibilities and good electrochemical performances. The solvothermal reaction medium can be reductant-free. The solubilizing agent can improve the solubility of the inorganic reactants such as the lithium source, the manganese source, and the phosphoric acid in the organic solvent. By adding the solubilizing agent in the organic solvent, the solubility of the inorganic reactants in the organic solvent can be increased and the incompatibility problem between the inorganic reactants and the organic solvent can be solved. The solubilizing agent is complexed with the metal ions of the reactants to form an intermediate complex, which improves the dispersion and dissolution of the metal ions in the organic solvent. During the solvothermal reacting, since the solubilizing agent is uniformly wrapped on the surface of the product, the surface energy of the product particles can be greatly reduced, and the size and morphology of the product can be effectively controlled so that the electrochemical performance of the product is improved. Furthermore, the solubilizing agent forms an electrical double layer on the surface of the product particles, and the product particles can be charged, so that an aggregation of the product particles can be prevented to ensure the high purity and consistency of the product.

In addition, the mixing order of the divalent manganese source, the lithium source, and the phosphate source has an affect on the product, such that a different mixing order leads to a different product. Contrary to the mixing orders which are adding the divalent manganese source to a mixture of the lithium source and the phosphate source, and adding the lithium source to a mixture of the divalent manganese source and the phosphate source, the mixing order described in steps S11 to S13 and steps A21 to A23 can achieve a relatively high electrochemical performance of the product. During the portion by portion adding of the first liquid solution in step S13 and the second liquid solution in step A23, the lithium ions are largely in excess to the added first and second liquid solutions.

### EXAMPLE 1

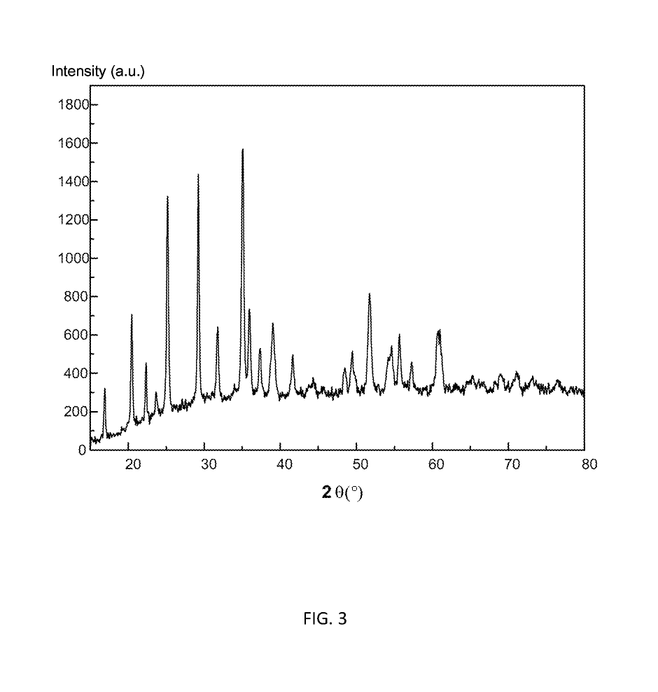

70 mL of ethylene glycol and 30 mL of APEO are mixed uniformly, added with 7.916 g of manganese (II) chloride tetrahydrate, and mechanically stirred for about 60 minutes to form a homogeneous manganese (II) chloride solution. 3 mL of phosphoric acid is added drop by drop to the manganese (II) chloride solution and mechanically stirred for about 2 hours to form a homogeneous first liquid solution. 5.035 g of lithium hydroxide monohydrate is then added to 100 mL of ethylene glycol and mechanically stirred for about 60 minutes to form a homogeneous lithium hydroxide solution. The first liquid solution is added drop by drop to the lithium hydroxide solution, stirred for about 60 minutes, sealed in an autoclave, and reacted at a constant temperature of about 180° C. for about 5 hours. The obtained product is centrifuged, washed, and dried to obtain the lithium manganese phosphate. Referring to FIG. 3, XRD test is processed to the cathode active material. The XRD pattern shown in FIG. 3 matches a standard XRD pattern of LiMnPO₄, which indicates that the product is LiMnPO₄. There is no impurity peak observed in FIG. 3, indicating that the obtained product is pure phase LiMnPO₄.

The lithium manganese phosphate is mixed with 15 wt % of sucrose and grinded for about 30 minutes to form a mixture. The mixture is calcined at a temperature of about 650° C. for about 6 hours in a nitrogen atmosphere, and then cooled to room temperature to obtain a cathode active material. A lithium ion battery is assembled by having the cathode active material and cycled to test the charge and discharge performance.

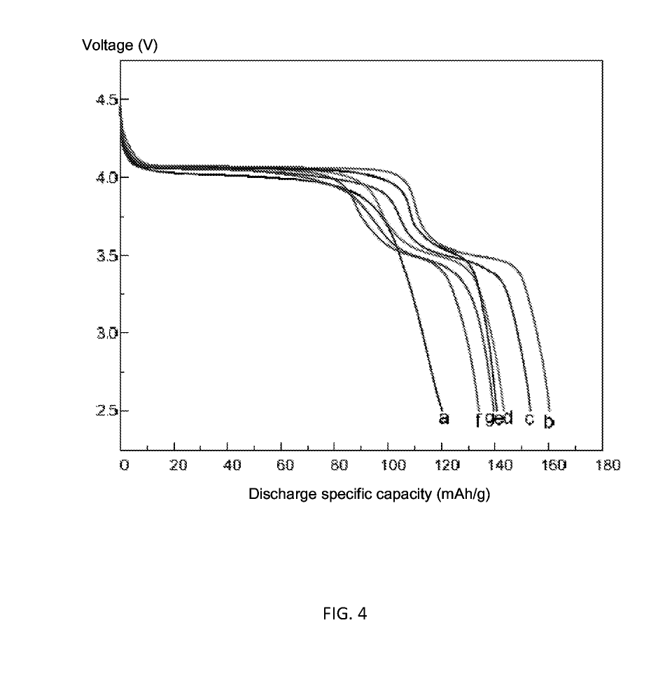

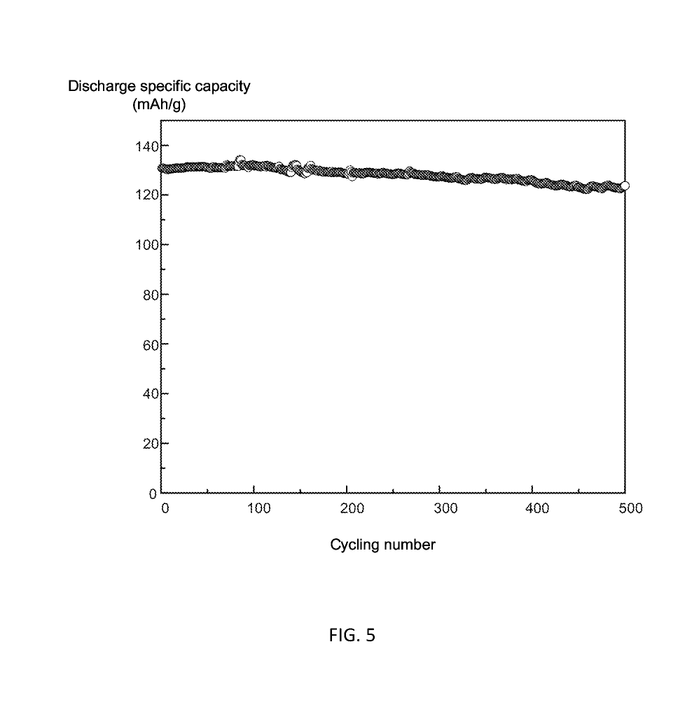

Referring to FIG. 4, the curve a is the discharge voltage curve of the battery of Example 1, which is galvanostatic charged/discharged at a current rate of 0.1 C, and the discharge specific capacity is 120.3 mAh/g.

### EXAMPLE 2

70 mL of ethylene glycol and 30 mL of APEO are mixed uniformly, added with 5.533 g of manganese (II) chloride tetrahydrate and 3.3362 g of ferrous sulfate (FeSO₄.7H₂O), and mechanically stirred for about 60 minutes to form a homogeneous manganese (II) chloride and ferrous sulfate solution. 3 mL of phosphoric acid is added drop by drop to the solution and mechanically stirred for about 2 hours to form a homogeneous first liquid solution. 5.035 g of lithium hydroxide monohydrate is then added to 100 mL of ethylene glycol and mechanically stirred for about 60 minutes to form a homogeneous lithium hydroxide solution. The first liquid solution is added drop by drop to the lithium hydroxide solution, stirred for about 60 minutes, sealed in an autoclave, and reacted at a constant temperature of about 180° C. for about 5 hours. The obtained product is centrifuged, washed, and dried to obtain the lithium manganese iron phosphate. The lithium manganese iron phosphate is mixed with 15 wt % of sucrose and grinded for about 30 minutes to form a mixture. The mixture is calcined at a temperature of about 650° C. for about 6 hours in a nitrogen atmosphere, and then cooled to room temperature to obtain a cathode active material. A lithium ion battery can be assembled the same way as the lithium ion battery in Example 1, except that the cathode active material is formed by the method in Example 2. The lithium ion battery is cycled to test the charge and discharge performance.

In FIG. 4, the curve b is the discharge voltage curve of the battery of Example 2 galvanostatic charged/discharged at a current rate of 0.1 C, and the discharge specific capacity is 160.5 mAh/g.

Referring to FIG. 5, the lithium ion battery is cycled for 500 times at a current rate of 1 C, and the capacity retention is about 94.5%, which reveals that the Fe doping in the LiMnPO₄ can increase the discharge specific capacity and the capacity retention.

### EXAMPLE 3

90 mL of ethylene glycol and 10 mL of APEO are mixed uniformly, added with 5.533 g of manganese (II) chloride tetrahydrate and 3.3362 g of FeSO₄.7H₂O, and mechanically stirred for about 60 minutes to form a homogeneous manganese (II) chloride and ferrous sulfate solution. 3 mL of phosphoric acid is added drop by drop to the solution and mechanically stirred for about 2 hours to form a homogeneous first liquid solution. 5.035 g of lithium hydroxide monohydrate is then added to 100 mL of ethylene glycol and mechanically stirred for about 60 minutes to form a homogeneous lithium hydroxide solution. The first liquid solution is added drop by drop to the lithium hydroxide solution, stirred for about 60 minutes, sealed in an autoclave, and reacted at a constant temperature of about 180° C. for about 5 hours. The obtained product is centrifuged, washed, and dried to obtain the lithium manganese iron phosphate. The lithium manganese iron phosphate is mixed with 12 wt % of sucrose and grinded for about 30 minutes to form a mixture. The mixture is calcined at a temperature of about 650° C. for about 6 hours in a nitrogen atmosphere, and then cooled to room temperature to obtain a cathode active material. A lithium ion battery can be assembled the same way as the lithium ion battery in Example 1, except that the cathode active material is formed by the method in Example 3. The lithium ion battery is cycled to test the charge and discharge performance.

In FIG. 4, the curve c is the discharge voltage curve of the battery of Example 3 galvanostatic charged/discharged at a current rate of 0.1 C, and the discharge specific capacity is 153.3 mAh/g, which shows that the discharge specific capacity decreases with the amount of APEO.

### EXAMPLE 4

60 mL of ethylene glycol and 40 mL of APEO are mixed uniformly, added with 5.533 g of manganese (II) chloride tetrahydrate and 3.3362 g of FeSO₄.7H₂O, and mechanically stirred for about 60 minutes to form a homogeneous manganese (II) chloride and ferrous sulfate solution. 3 mL of phosphoric acid is added drop by drop to the solution and mechanically stirred for about 2 hours to form a homogeneous first liquid solution. 5.035 g of lithium hydroxide monohydrate is then added to 100 mL of ethylene glycol and mechanically stirred for about 60 minutes to form a homogeneous lithium hydroxide solution. The first liquid solution is added drop by drop to the lithium hydroxide solution, stirred for about 60 minutes, sealed in an autoclave, and reacted at a constant temperature of about 180° C. for about 5 hours. The obtained product is centrifuged, washed, and dried to obtain the lithium manganese iron phosphate. The lithium manganese iron phosphate is mixed with 12 wt % of sucrose and grinded for about 30 minutes to form a mixture. The mixture is calcined at a temperature of about 650° C. for about 6 hours in a nitrogen atmosphere, and then cooled to room temperature to obtain a cathode active material. A lithium ion battery can be assembled the same way as the lithium ion battery in Example 1, except that the cathode active material is formed by the method in Example 4. The lithium ion battery is cycled to test the charge and discharge performance.

In FIG. 4, the curve d is the discharge voltage curve of the battery of Example 4 galvanostatic charged/discharged at a current rate of 0.1 C, and the discharge specific capacity is 143.3 mAh/g. The amount of APEO is not the more the better.

### EXAMPLE 5

0.2 g of graphene and 0.3 g of carbon naontubes are added to 60 mL of ethylene glycol and 40 mL of APEO, and are mixed uniformly by grinding for about 1 hour and ultrasonically dispersing for about 2 hours. 5.533 g of manganese (II) chloride tetrahydrate and 3.3362 g of FeSO₄.7H₂O are then further added and mechanically stirred for about 60 minutes to form a homogeneous manganese (II) chloride/ferrous sulfate/carbon solution. 3 mL of phosphoric acid is added drop by drop to the solution and mechanically stirred for about 2 hours to form a homogeneous second liquid solution. 3.316 g of lithium hydroxide monohydrate is then added to 100 mL of ethylene glycol and mechanically stirred for about 60 minutes to form a homogeneous lithium hydroxide solution. The second liquid solution is added drop by drop to the lithium hydroxide solution, stirred for about 60 minutes, sealed in an autoclave, and reacted at a constant temperature of about 180° C. for about 5 hours. The obtained product is centrifuged, washed, and dried to obtain the lithium manganese iron phosphate/carbon composite material. The lithium manganese iron phosphate/carbon composite material is mixed with 6 wt % of sucrose and grinded for about 30 minutes to form a mixture. The mixture is calcined at a temperature of about 650° C. for about 6 hours in a nitrogen atmosphere, and then cooled to room temperature to obtain a cathode active material. A lithium ion battery is assembled and same with the lithium ion battery in Example 1, except that the cathode active material is formed by the method in Example 5. The lithium ion battery is cycled to test the charge and discharge performance.

In FIG. 4, the curve e is the discharge voltage curve of the battery of Example 5 galvanostatic charged/discharged at a current rate of 0.1 C, and the discharge specific capacity is 140.7 mAh/g, which shows that adding the carbonaceous material decreases the discharge specific capacity, but increase the electrical conductivity which can improve the high current rate performance.

### COMPARATIVE EXAMPLE 1

100 mL of ethylene glycol is added with 5.533 g of manganese (II) chloride tetrahydrate and 3.3362 g of FeSO₄.7H₂O, and mechanically stirred for about 60 minutes to form a homogeneous manganese (II) chloride and ferrous sulfate solution. 3 mL of phosphoric acid is added drop by drop to the solution and mechanically stirred for about 2 hours to form a homogeneous first liquid solution. 5.035 g of lithium hydroxide monohydrate is then added to 100 mL of ethylene glycol and mechanically stirred for about 60 minutes to form a homogeneous lithium hydroxide solution. The first liquid solution is added drop by drop to the lithium hydroxide solution, stirred for about 60 minutes, sealed in an autoclave, and reacted at a constant temperature of about 180° C. for about 5 hours. The obtained product is centrifuged, washed, and dried to obtain the lithium manganese iron phosphate. The lithium manganese iron phosphate is mixed with 12 wt % of sucrose and grinded for about 30 minutes to form a mixture. The mixture is calcined at a temperature of about 650° C. for about 6 hours in a nitrogen atmosphere, and then cooled to room temperature to obtain a cathode active material. A lithium ion battery can be assembled the same way as the lithium ion battery in Example 1, except that the cathode active material is formed by the method in Comparative Example 1. The lithium ion battery is cycled to test the charge and discharge performance.

In FIG. 4, the curve f is the discharge voltage curve of the battery of Comparative Example 1 galvanostatic charged/discharged at a current rate of 0.1 C, and the discharge specific capacity is 134 mAh/g.

### COMPARATIVE EXAMPLE 2

70 mL of ethylene glycol and 30 mL of APEO are mixed uniformly, added with 5.533 g of manganese (II) chloride tetrahydrate and 3.3362 g of FeSO₄.7H₂O, and mechanically stirred for about 60 minutes to form a homogeneous manganese (II) chloride and ferrous sulfate solution. 3 mL of phosphoric acid is added drop by drop to the solution and mechanically stirred for about 2 hours to form a homogeneous first liquid solution. 5.035 g of lithium hydroxide monohydrate is then added to 100 mL of ethylene glycol and mechanically stirred for about 60 minutes to form a homogeneous lithium hydroxide solution. The lithium hydroxide solution is added drop by drop to the first liquid solution, stirred for about 60 minutes, sealed in an autoclave, and reacted at a constant temperature of about 180° C. for about 5 hours. The obtained product is centrifuged, washed, and dried to obtain the lithium manganese iron phosphate. The lithium manganese iron phosphate is mixed with 12 wt % of sucrose and grinded for about 30 minutes to form a mixture. The mixture is calcined at a temperature of about 650° C. for about 6 hours in a nitrogen atmosphere, and then cooled to room temperature to obtain a cathode active material. A lithium ion battery can be assembled the same way as the lithium ion battery in Example 1, except that the cathode active material is formed by the method in Comparative Example 2. The lithium ion battery is cycled to test the charge and discharge performance.

In FIG. 4, the curve g is the discharge voltage curve of the battery of Comparative Example 2 galvanostatic charged/discharged at a current rate of 0.1 C, and the discharge specific capacity is 139.6 mAh/g, which shows that the mixing order of the reactants greatly affects the discharge specific capacity of the battery.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for making lithium manganese phosphate, the method comprising:
mixing and dissolving a divalent manganese source, a lithium source, and a phosphate source in a solvothermal reaction medium to form a mixed solution, the solvothermal reaction medium comprising an organic solvent and a solubilizing agent; and
solvothermal reacting the mixed solution.

2. The method of claim 1, further comprising dissolving a metal doping source with the divalent manganese source, the lithium source, and the phosphate source in the solvothermal reaction medium to form the mixed solution comprising the metal dopant source, the divalent manganese source, the lithium source, and the phosphate source mixed with each other.

3. The method of claim 2, wherein the metal doping source comprises a doping element selected from the group consisting of alkaline-earth metal elements, Group-13 elements, Group-14 elements, transition metal elements, rare-earth elements, and combinations thereof.

4. The method of claim 2, wherein the metal doping source comprises a doping element, the doping element being Fe.

5. The method of claim 1, wherein the divalent manganese source is selected from the group consisting of manganese chloride, manganese nitrate, manganese sulfate, manganese acetate, and combinations thereof.

6. The method of claim 1, wherein the lithium source is selected from the group consisting of lithium hydroxide, lithium acetate, lithium carbonate, lithium oxalate, and combinations thereof.

7. The method of claim 1, wherein the phosphate source is selected from the group consisting of phosphoric acid, lithium dihydrogen phosphate, ammonium phosphate, diammonium hydrogen phosphate, ammonium dihydrogen phosphate, and combinations thereof.

8. The method of claim 1, wherein the organic solvent is selected from the group consisting of diols, polyols, and combinations thereof.

9. The method of claim 1, wherein the organic solvent is selected from the group consisting of ethylene glycol, glycerol, diethylene glycol, triethylene glycol, tetraethylene glycol, butanetriol, n-butanol, isobutanol, and combinations thereof.

10. The method of claim 1, wherein the solubilizing agent is selected from the group consisting of alkyl phenol polyoxyethylene ether, fatty alcohol ethoxylate, polyethylene glycol, polyolester, and combinations thereof.

11. The method of claim 1, wherein a volume ratio of the organic solvent and the solubilizing agent is in a range from about 9:1 to about 3:2.

12. The method of claim 1, wherein the solvothermal reaction medium is water-free.

13. The method of claim 1, wherein a mass percentage of water in the mixed solution is less than 1%.

14. The method of claim 1, wherein the mixing and dissolving the divalent manganese source, the lithium source, and the phosphate source in the solvothermal reaction medium to form the mixed solution comprises:
providing the divalent manganese source solution, the lithium source solution, and the phosphate source solution;
adding the phosphate source solution portion by portion to the divalent manganese source solution to form a first liquid solution; and
adding the first liquid solution portion by portion to the lithium source solution to form the mixed solution.

15. The method of claim 1, wherein the solvothermal reacting is carried out at a temperature of about 120° C. to about 240° C.

16. The method of claim 1, further comprising heating the lithium manganese phosphate in a protective gas at a temperature range from about 200° C. to about 800° C.

17. The method of claim 1, wherein the solvothermal reaction medium further comprises a carbonaceous nanosized material dispersed in the organic solvent.

18. The method of claim 17, wherein the carbonaceous nanosized material is selected from the group consisting of graphene, carbon nanotubes, carbon nanofibers, carbon nanoballs, and combinations thereof.

19. A method for making lithium manganese phosphate/carbon composite material comprising:
dispersing a carbonaceous material in a solvothermal reaction medium to form a dispersed solution, the solvothermal reaction medium comprising an organic solvent and a solubilizing agent;
mixing and dissolving a divalent manganese source, a lithium source, and a phosphate source in the dispersed solution to form a mixed solution; and
solvothermal reacting the mixed solution.

20. The method of claim 19, wherein the carbonaceous material is selected from the group consisting of graphene, carbon nanotubes, carbon nanofibers, carbon nanoballs, and combinations thereof.
